(19) United States
(12) Patent Application Publication
(10) Pub. No.: US 2023/0305832 A1
(43) Pub. Date: Sep. 28, 2023

(54) METHOD FOR VALIDATING A NEW SOFTWARE STATUS IN A REDUNDANT SYSTEM

(71) Applicant: MERCEDES-BENZ GROUP AG, Stuttgart (DE)

(72) Inventors: Philipp SCHINDLER, Karlsruhe (DE); Oliver PÖLLNY, Stuttgart (DE)

(21) Appl. No.: 18/023,410

(22) PCT Filed: Jul. 9, 2021
(86) PCT No.: PCT/EP2021/069131

§ 371 Date: Feb. 27, 2023

(30) Foreign Application Priority Data
Aug. 31, 2020 (DE) 10 2020 005 352.1

(51) Int. Cl. G06F 8/65; B60W 50/14

(52) U.S. Cl. CPC G06F 8/65; B60W 50/14; B60W 2050/146

(57) ABSTRACT

A method for validating a software status of a vehicle in a system involves testing the software in the vehicle in the system. The system controls the vehicle according to input data and subsequently records output data of the vehicle. In an inactive state of the system, an in each case non-productive, old and new software status are compared in parallel, and by activating the system to an active state, a change to the productive software status takes place.

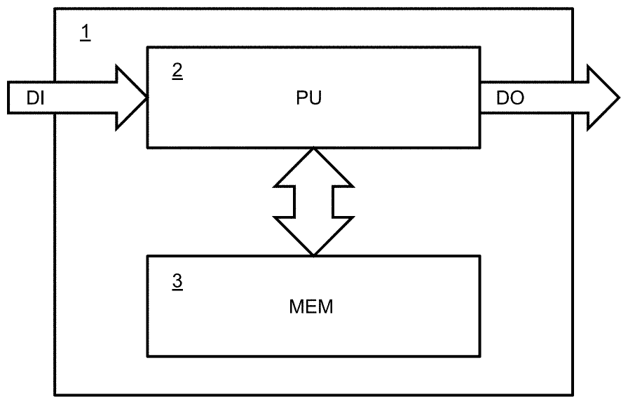

### BACKGROUND AND SUMMARY OF THE INVENTION

Exemplary embodiments of the invention relate to a method for validating a software status of a vehicle and to a computer program product comprising a code device which is suitable for carrying out the steps of the method when it is run on a computer.

WO 2007/100292 A1 discloses a method for evaluating an application for controlling a process within an automation system and a controller of such an automation system. The application is stored in a controller, and at least two versions of it are present within the controller. The method comprises the following steps: inputting an input signal obtained from the process into the different versions of the application, executing tasks based on this input signal in the controller for the different versions, generating a report comprising comparisons of the outputs from the different versions of the application, and evaluating, based on the generated report, the version(s) not used for controlling the process.

The constant development of software and of systems for the automated securing of software, as well as the overlapping existence of several generations thereof, means that the effort required for securing such software and systems increases enormously, since the functionalities of the software or system are safety-critical.

For this securing, vehicles on which the new software is tested must be accordingly kept available. If a “closed-loop system”, i.e., a system that controls the vehicle according to input data, is operated and tested, then access to old data and records is only very restricted and therefore new data must actually be entered or imported. This is associated with high costs and a relatively large amount of effort. Typically, attempts are made to record data in software development and only re-simulate it with new software when changes occur over its lifetime. This works well as long as the response of the system does not change.

Exemplary embodiments of the present invention provide a way of validating a software status and of having unrestricted access to old data and records in the event of a change to software statuses, while keeping the costs and effort low.

According to a first aspect of the invention, there is a method for validating a software status of a vehicle in a system, in which the software on the vehicle is tested, wherein the system controls the vehicle according to input data and subsequently records output data of the vehicle, and wherein in an inactive state of the system, an in each case non-productive, old and new software status are compared in parallel, and by activating the system to an active state, a change to the productive software status takes place.

The present invention compares the old software status with the new software status in the event of a change to software statuses. Preferably, parallel software execution capabilities and a comparison of multiple software paths are used to compare an old software status to a new software status.

According to a preferred exemplary embodiment of the invention, in a first path from the plurality of software paths, the information obtained from the recording of the output data of the vehicle is processed with an old software status.

According to the preferred exemplary embodiment of the invention, a new software status is applied in a second path from the plurality of software paths based on the input data of the vehicle, and deviations between the old and the new software status are detected and stored in a comparison path. Preferably, the application, detection, and storage are performed during vehicle operation in the inactive state of the system. In particular, the system is installed but not activated, or the system is currently not in use.

When changing to the active state of the system, the software component to be tested is preferably configured to the production series status and the system is available after a predefined time interval. In the case of adaptations of existing algorithms, this process can advantageously be carried out quickly, since only the weights of a neural network have to be reloaded, which can be done within a few seconds.

According to another preferred exemplary embodiment of the invention, system reactions of the old and new software status are compared with the reaction of a driver of the vehicle. Advantageously, this provides further input for “natural” or correct driving.

According to a second aspect of the invention, there is a computer program product comprising a code device suitable for carrying out the steps of a method according to the first aspect of the invention when it is run on a computer.

Advantageously, the invention compares an old with a new software status on existing hardware. This is preferably carried out online, whereby new scenes are checked. This avoids “overfitting” on existing data. Furthermore, this securing can be realized by means of a customer fleet that has installed the hardware but has not yet activated it or is not currently using it.

Furthermore, a field comparison with known quality is directly available through the comparison with an old, known software status. In addition, preferably exclusively deviations from the new to the old software status can be transmitted, and thus critical or interesting scenes are selected automatically.

This provides a way of validating a software status and of having unrestricted access to old data and records in the event of a change of software statuses, thereby keeping the costs and effort low.

### BRIEF DESCRIPTION OF THE SOLE DRAWING

The invention is explained in more detail below using a preferred exemplary embodiment with reference to the sole drawing, which shows a software-based implementation according to a preferred exemplary embodiment of the invention.

### DETAILED DESCRIPTION

In a preferred exemplary embodiment of the invention for validating a software status of a vehicle in a system in which the software on the vehicle is tested, software is executed in parallel and multiple software paths are compared in order to compare an old software status to a new software status. The system controls the vehicle according to input data, and subsequently output data of the vehicle are recorded.

The information is processed with an old software status in a path of a control unit. Based on the input data of the vehicle, a new software status is applied on another path from the plurality of software paths, and deviations are then detected and stored in a comparison path.

In the preferred exemplary embodiment of the invention, this takes place while the vehicle is in operation, but without the system being activated. If the customer wishes to activate the system, the software component that is about to be checked is reconfigured to the production series status and the system is made available to the driver of the vehicle again after a short time.

The sole FIGURE shows a schematic block diagram of a software-based implementation as per another preferred exemplary embodiment of the invention. According to this preferred exemplary embodiment of the invention, the provided unit 1 comprises a processing unit (PU) 2, which is provided on a single chip or on a chip module. The processing unit 2 comprises any processor unit or any computer unit comprising a control unit that executes control using software routines of a control program, with the software routines being stored in a memory unit 3, also referred to as memory (MEM). Program code instructions are retrieved from the MEM 3 and loaded into the control unit of the PU 2 to execute the individual method steps of the method according to the invention. The processing steps of blocks 1 and 2 can be performed based on input data, also referred to as data input (DI), and can generate output data, also referred to as data output (DO), wherein the input data DI correspond to data or signals that have been communicated and/or detected, and the output data DO can correspond to data or signals that are communicated or intended to be communicated with other units.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. A method for validating a software status of a vehicle in a system in which software on the vehicle is tested, the method comprising:
comparing, in parallel and in an inactive state of the system, old and new software status, wherein the compared old and new software status are non-production; and
activating the system to an active state and changing production software executed by the system, wherein the system controls the vehicle according to input data and subsequently records output data of the vehicle.

9. The method of claim 8, wherein in a first path from a plurality of software paths, information obtained from the recording of the output data of the vehicle is processed with the old software status.

10. The method of claim 9, wherein a new software status is applied in a second path from the plurality of software paths based on the input data of the vehicle, and deviations between the old and the new software status are detected and stored in a comparison path.

11. The method of claim 10, wherein the application of the new software status in the second path, the detection of deviations, and the storage of deviations are performed during vehicle operation in the inactive state of the system.

12. The method of claim 11, wherein when changing to the active state of the system, a software component to be tested is configured to production series status and the system is available after a predefined time interval.

13. The method of claim 8, wherein reactions of the system of the old and new software status are compared with the reaction of a driver of the vehicle.

14. A non-transitory computer program product comprising code, which when executed by a processor causes the processor to:
compare, in parallel and in an inactive state of the system, old and new software status, wherein the compared old and new software status are non-production; and
activate the system to an active state and change production software executed by the system, wherein the system controls the vehicle according to input data and subsequently records output data of the vehicle.
